(19) United States
(12) Patent Application Publication
(10) Pub. No.: US 2013/0264268 A1
(43) Pub. Date: Oct. 10, 2013

(54) SEPARATOR

(71) Applicants: SEIKO EPSON CORPORATION, Tokyo (JP); SHINSHU UNIVERSITY, Matsumoto-shi (JP)

(72) Inventors: Satomi YOSHIOKA, Shiojiri-shi (JP); Hiroshi YAGI, Tatsuno-machi (JP); Shigetaka SHIMODAIRA, Matsumoto-shi (JP)

(21) Appl. No.: 13/849,045

(22) Filed: Mar. 22, 2013

(30) Foreign Application Priority Data
Apr. 5, 2012 (JP) 2012-86515

(51) Int. Cl. B01D 71/74

(52) U.S. Cl. CPC B01D 71/74
USPC 210/321.72; 210/500.25; 210/321.6

(57) ABSTRACT

A separator fractionates a dispersion of cells including cells having phagocytic activity corresponding to a size of the cells to obtain a dispersion in which the content of the cells having phagocytic activity is higher than that of the dispersion, and includes a filter, at least part of the filter having a hydrophilic surface as a result of being covered with at least one of a self-assembled monolayer that includes an alkanethiol having a nonionic hydrophilic group that is formed on a gold thin film via a sulfur-gold bond, and a homopolymer or a copolymer of an ester of (meth)acrylic acid and at least some of hydrophilic groups of phospholipids that form a biomembrane. The separator is thus configured so that clogging of the filter is suppressed, and the separation efficiency is improved.

Japanese Patent Application No. 2012-86515 filed on Apr. 5, 2012, is hereby incorporated by reference in its entirety.

### BACKGROUND OF THE INVENTION

The present invention relates to a separator.

It has been known that cells having phagocytic activity (e.g., monocytes, dendritic cells, and macrophages) are useful for the treatment of various diseases. For example, dendritic cell therapy collects peripheral blood from the patient, removes only monocytes from the collected peripheral blood, subjects the monocytes to in vitro differentiation into dendritic cells, allows the dendritic cells to recognize the cancer antigen of the patient, and administers the dendritic cells to the patient. However, peripheral blood collected from the patient contains a large amount of lymphocytes and the like in addition to monocytes. Therefore, a separator that can efficiently separate monocytes from bone-marrow blood, peripheral blood, or the like has been desired.

Cells such as monocytes have been separated by (1) a specific gravity centrifugal method, (2) an adhesion method, (3) a magnetic bead method, or the like. However, these methods pose various problems (e.g., contamination risk, cellular damage, low separation efficiency, long-time treatment process, and high reagent cost).

Therefore, a separator that utilizes a filter has been proposed as a more convenient means (see JP-A-2003-274923).

However, monocytes and dendritic cells that are derived/differentiated from monocytes exhibit high adhesion to a material (e.g., container or substrate) that comes in contact with the cells. More specifically, an adhesion mechanism via cell adhesion molecules (e.g., cadherin, integrin family, and selectin) functions in vascular endothelical cells, lymph vessels, and the like. It has been considered that cells such as monocytes adhere to a non-biomaterial (non-adhesive protein material) (e.g., plastic or glass) that forms a container, a substrate, or the like through a mechanism whereby a cell surface adhesion protein (receptor) adheres and binds to an adhesion protein (ligand) adsorbed on the non-biomaterial, so that the cells adhere to the container or the substrate (H. Iwata, “Biomaterial”, Kyoritsu Shuppan Co., Ltd., 2005).

Monocytes contained in peripheral blood migrate to the outside of the blood vessel, and differentiate into macrophages. Macrophages also adhere to a container or a substrate in the same manner as monocytes and dendritic cells. Specifically, a receptor (macrophage receptor with collagenous structure (MARCO)) that is present on the surface of a macrophage and is involved in non-specific adhesion to a non-biological foreign substance recognizes a non-biological foreign substance, and the macrophage engulfs the foreign substance. When the non-biological foreign substance is a small plastic bead, the macrophage absorbs and engulfs the foreign substance. When the foreign substance is too large to engulf (e.g., container or substrate), the macrophage continuously recognizes and absorbs the foreign substance (e.g., container or substrate).

Therefore, it is considered that monocytes, dendritic cells, and macrophages having phagocytic activity more strongly adhere to a non-biomaterial (e.g., container or substrate) as compared with other blood cells. Accordingly, when separating cells having phagocytic activity from peripheral blood or the like using a filter, cells having phagocytic activity easily adhere to the surface of the filter, and clog the filter as compared with other blood cells.

In order to separate cells such as monocytes having high adhesion using a filter, it has been desired to suppress clogging of the filter by suppressing adhesion of cells.

### SUMMARY

The invention may provide a separator for which clogging of a filter is suppressed, and the separation efficiency is improved.

According to one aspect of the invention, there is provided a separator that fractionates a dispersion of cells including cells having phagocytic activity corresponding to a size of the cells to obtain a dispersion in which a content of the cells having phagocytic activity is higher than that of the dispersion, the separator including:

a filter,

at least part of the filter having a hydrophilic surface as a result of being covered with at least one of a self-assembled monolayer that includes an alkanethiol having a nonionic hydrophilic group that is formed on a gold thin film via a sulfur-gold bond, and a homopolymer or a copolymer of an ester of (meth)acrylic acid and at least some of hydrophilic groups of phospholipids that form a biomembrane.

### BRIEF DESCRIPTION OF THE SEVERAL VIEWS OF THE DRAWING

FIG. 1A is a plan view illustrating a filter included in a separator according to one embodiment of the invention, and FIG. 1B is a cross-sectional view taken along the line IB-IB in FIG. 1A.

FIG. 2A is a perspective view illustrating a separator 1 according to one embodiment of the invention, and FIG. 2B is a plan view illustrating the separator 1 according to one embodiment of the invention, and a cross-sectional view taken along the line A-A in the plan view.

FIG. 3 is a cross-sectional view illustrating a separator 2 according to one embodiment of the invention.

FIGS. 4A and 4B are cross-sectional views illustrating an example in which the separator 1 according to one embodiment of the invention is used.

FIGS. 5A and 5B are cross-sectional views illustrating an example in which the separator 2 according to one embodiment of the invention is used.

FIGS. 6A and 6B are graphs illustrating the measurement results obtained in Examples 1 to 3 and Comparative Example 1.

### DETAILED DESCRIPTION OF THE EMBODIMENT

(1) According to one embodiment of the invention, there is provided a separator that fractionates a dispersion of cells including cells having phagocytic activity corresponding to a size of the cells to obtain a dispersion in which a content of the cells having phagocytic activity is higher than that of the dispersion, the separator including:

a filter,

at least part of the filter having a hydrophilic surface as a result of being covered with at least one of a self-assembled monolayer that includes an alkanethiol having a nonionic hydrophilic group that is formed on a gold thin film via a sulfur-gold bond, and a homopolymer or a copolymer of an ester of (meth)acrylic acid and at least some of hydrophilic groups of phospholipids that form a biomembrane.

According to the above configuration, at least part of the filter included in the separator has a hydrophilic surface as a result of being covered with at least one of a self-assembled monolayer that includes an alkanethiol having a nonionic hydrophilic group that is formed on a gold thin film via a sulfur-gold bond, and a homopolymer or a copolymer of an ester of (meth)acrylic acid and at least some of hydrophilic groups of phospholipids that form a biomembrane. When it is desired to suppress adhesion of cells having phagocytic activity to each member of a filter or the like, it is necessary to treat each member so that the macrophage receptor with collagenous structure (MARCO) present on the surface of the cells does not recognize each member as a foreign substance. According to the above configuration, the surface of the filter is made hydrophilic by covering the surface of the filter with a coating film. This makes it possible to suppress a situation in which the MARCO receptors of monocytes and dendritic cells recognize each member as a foreign substance, and suppress adhesion of the cells to the filter. Accordingly, since cells having phagocytic activity rarely adhere to the surface of the filter, it is possible to provide a separator for which clogging of the filter is suppressed, and the separation efficiency is improved. Moreover, blood cells contained in blood can be separated using the separator having a simple configuration that effectively utilizes placement of the filter and flow control. Specifically, cells can be inexpensively separated using a closed system without using a reagent, differing from known cell separation techniques (e.g., centrifugation and magnetic beads).

(2) In the separator, the nonionic hydrophilic group may be a polyethylene glycol group.

According to the above configuration, since the long-chain molecules having a hydrophilic polyethylene glycol group and present on the surface of the member make thermal motions, it is possible to reduce a situation in which a receptor that is present on the surface of the cells and is involved in non-specific adhesion binds to the surface of the member.

(3) In the separator, the phospholipids that form the biomembrane may be glycerophospholipids.

According to the above configuration, since the long-chain molecules having a hydrophilic phosphoric acid group and present on the surface of the member make thermal motions, it is possible to reduce a situation in which a receptor that is present on the surface of the cells and is involved in non-specific adhesion binds to the surface of the member.

(4) In the separator, the ester of (meth)acrylic acid and at least some of the hydrophilic groups of the phospholipids that form the biomembrane may be 2-(meth)acryloyloxyethylphosphorylcholine.

(5) In the separator, the cells having phagocytic activity may have a scavenger receptor on the surface thereof.

(6) In the separator, the cells having phagocytic activity may be at least one type of cells among monocytes, dendritic cells, and macrophages.

(7) In the separator, the hydrophilic surface of the filter may have a contact angle with water of 70° or less.

(8) In the separator, the hydrophilic surface may be formed in at least an area with which the cells having phagocytic activity come in contact.

(9) The separator may further include a first container that has an opening, and a tubular second container that has a first opening, a second opening that is opposite to the first opening, and the filter that closes the second opening, the filter of the second container may be placed in the first container, and at least part of an inner wall surface of the first container and the second container may have the hydrophilic surface.

According to the above configuration, at least part of the inner wall surface of the first container and the second container that may come in contact with the cells having phagocytic activity has the hydrophilic surface in addition to the surface of the filter. Accordingly, since the cells having phagocytic activity rarely adhere to the surface of the container, it is possible to provide a separator for which clogging of the filter is suppressed, and the separation efficiency is improved.

(10) The separator may further include a first container that has a first inlet and a first outlet, and a second container that has a second inlet and a second outlet, and is continuous with the first container through the filter, and at least part of an inner wall surface of the first container may have the hydrophilic surface.

According to the above configuration, at least part of the inner wall surface of the first container that may come in contact with the cells having phagocytic activity has the hydrophilic surface in addition to the surface of the filter. Accordingly, since the cells having phagocytic activity rarely adhere to the surface of the container, it is possible to provide a separator for which clogging of the filter is suppressed, and the separation efficiency is improved.

Exemplary embodiments of the invention are described in detail below with reference to the drawings. Note that the following exemplary embodiments do not unduly limit the scope of the invention as stated in the claims. Note also that all of the elements described below should not necessarily be taken as essential elements of the invention.

### 1. CONFIGURATION OF SEPARATOR

The configuration of a separator according to one embodiment of the invention is described below. The configuration of a filter 10 included in the separator according to one embodiment of the invention, and separators 1 and 2 as an example of the separator according to one embodiment of the invention are described below. Note that the separator according to one embodiment of the invention is not particularly limited as long as the separator includes the filter 10. The configuration of the separator according to one embodiment of the invention is not limited to those of the separators 1 and 2.

1-1. Configuration of Filter

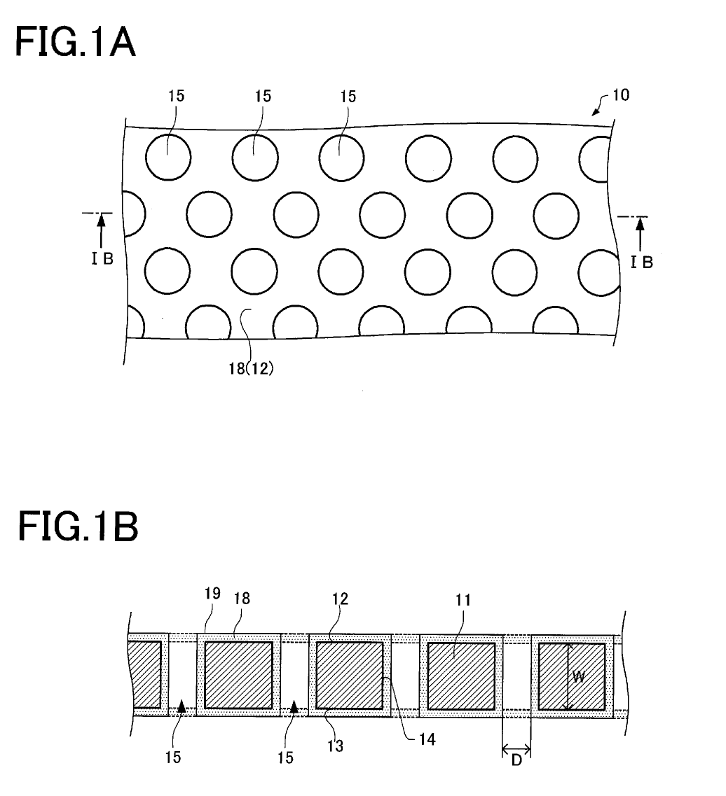

FIG. 1A is a plan view illustrating the filter 10 included in the separator according to one embodiment of the invention, and FIG. 1B is a cross-sectional view taken along the line IB-IB in FIG. 1A.

The filter 10 is used to fractionate a dispersion (separation target liquid) of cells including cells having phagocytic activity corresponding to the size of the cells to obtain a dispersion (residual component-containing liquid) in which the content of the cells having phagocytic activity is higher than that of the original dispersion (separation target liquid).

The cells having phagocytic activity refer to cells having a scavenger receptor (e.g., MARCO receptor) on the surface thereof. The cells having phagocytic activity may be at least one type of cells among monocytes, dendritic cells, and macrophages, for example.

As illustrated in FIGS. 1A and 1B, the filter 10 includes a substrate 11 that has a plurality of through-holes 15, and a coating film 18 that covers the surface of the substrate 11.

The substrate 11 has a first surface 12, and a second surface 13 that is opposite to the first surface 12. An inner wall surface 14 of the through-hole 15 is formed continuously with the first surface 12 and the second surface 13. In the example illustrated in FIGS. 1A and 1B, the substrate 11 is flat (i.e., has a flat surface). Note that the substrate 11 may be curved (i.e., may have a curved surface). A material for forming the substrate 11 may be selected from known materials (e.g., metal, resin, and glass) taking account of the composition of the separation target liquid and the like.

The thickness T of the substrate 11 and the pore size (diameter) D of the through-hole 15 may be appropriately set taking account of the composition of the separation target liquid. For example, when the separation target liquid is a dispersion of cells including cells having phagocytic activity, the thickness T of the substrate 11 may be 5 to 20 micrometers. The pore size D of the through-hole 15 (i.e., the pore size determined taking account of the thickness of the coating film 18) may be 30 to 50% of the size of the cells having phagocytic activity. Note that the thickness T of the substrate 11 and the pore size D of the through-hole 15 are not limited to the above ranges since the size differs between individual cells. The thickness T of the substrate 11 and the pore size D of the through-hole 15 can be appropriately adjusted depending on the size of cells.

The filter 10 is not particularly limited as long as the filter 10 allows cells having a size equal to or smaller than a given size to pass through when filtering the separation target liquid. The filter 10 may be a filter in which slit-like through-holes are formed (not illustrated in the drawings).

The coating film 18 may cover at least part of the filter. As illustrated in FIG. 1B, the coating film 18 may cover the first surface 12, the second surface 13, and the inner wall surface 14 of the substrate 11. The coating film 18 may cover only the first surface 12 and/or the second surface 13 (not illustrated in the drawings).

The coating film 18 includes at least one of (1) a self-assembled monolayer (SAM) that includes an alkanethiol having a nonionic hydrophilic group that is formed on a gold thin film via a sulfur-gold bond, and (2) a homopolymer or a copolymer of an ester of (meth)acrylic acid and at least some of the hydrophilic groups of phospholipids that form a biomembrane.

The term “self-assembled monolayer (SAM) used herein refers to an organic thin film that is formed by allowing organic molecules to be chemically adsorbed on the surface of a substrate through a chemical reaction between the organic molecules and the substrate material, and allowing the adsorbed molecules to gather closely due to the interaction between a plurality of organic molecules so that the molecules are orientated in an orderly manner.

When the coating film 18 includes (1) a self-assembled monolayer (SAM) that includes an alkanethiol having a nonionic hydrophilic group that is formed on a gold thin film via a sulfur-gold bond, the nonionic hydrophilic group (terminal functional group) may be a polyethylene glycol group. Specifically, a surface 19 of the filter 10 may include a polyethylene glycol group (PEG group).

The thickness of the gold thin film is not particularly limited. For example, the thickness of the gold thin film may be 30 to 1000 nm.

When the coating film 18 includes (2) a homopolymer or a copolymer of an ester of (meth)acrylic acid and at least some of the hydrophilic groups of phospholipids that form a biomembrane, the phospholipids that form the biomembrane may be glycerophospholipids. The ester of (meth)acrylic acid and at least some of the hydrophilic groups of the phospholipids that form the biomembrane may be 2-(meth)acryloyloxyethylphosphorylcholine (MPC polymer).

The surface 19 of the filter 10 exhibits hydrophilicity since the surface of the filter is covered with the coating film 18. The surface 19 may have a contact angle with water of 70° or less. The surface 19 may preferably have a contact angle with water of 30 to 50°.

When it is desired to suppress adhesion of cells having phagocytic activity to each member of a filter or the like, it is necessary to treat each member so that the macrophage receptor with collagenous structure (MARCO) present on the surface of the cells does not recognize each member as a foreign substance. In one embodiment of the invention, the surface 19 is made hydrophilic by covering the surface of the filter 10 with the coating film 18. This makes it possible to suppress a situation in which the MARCO receptors of monocytes and dendritic cells recognize each member as a foreign substance, and suppress adhesion of the cells to the filter 10. The details thereof are described later.

1-2. Configuration of Separator 1

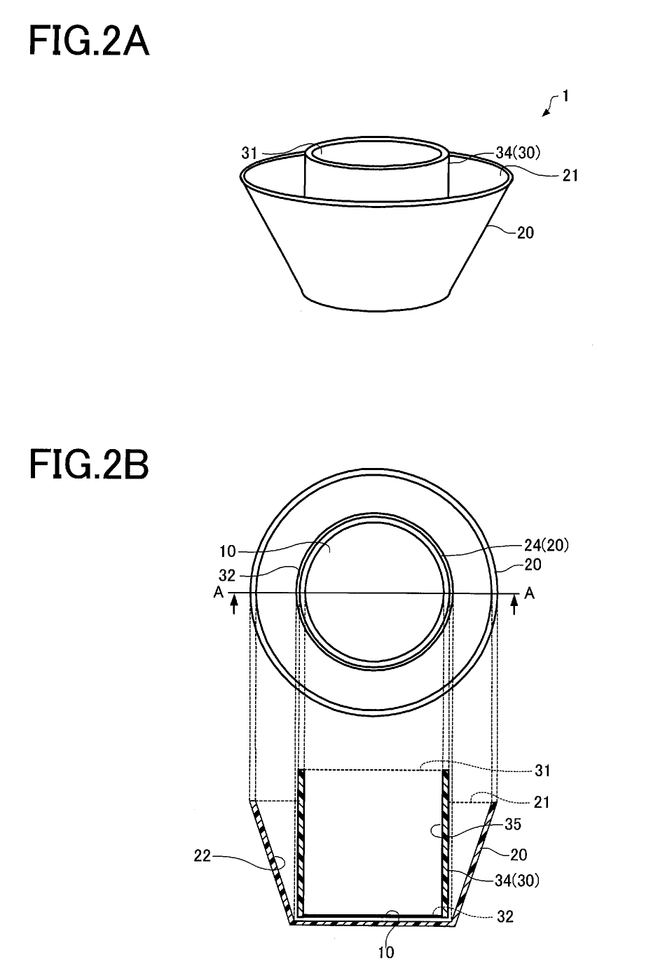

FIG. 2A is a perspective view illustrating the separator 1 according to one embodiment of the invention, and FIG. 2B is a plan view illustrating the separator 1 according to one embodiment of the invention, and a cross-sectional view taken along the line A-A.

The separator 1 according to one embodiment of the invention includes a first container 20 that has an opening 21, and a tubular second container 30 that has a first opening 31, a second opening 32 that is opposite to the first opening 31, and the filter 10 that closes the second opening 32, the filter 10 of the second container 30 being placed in the first container 20.

The first container 20 has the opening 21. The opening 21 functions as an inlet for the separation target liquid. The opening 21 also functions as an outlet for a filtrate that has passed through the filter 10. It suffices that the opening 21 have a size and a shape sufficient to remove a filtrate that has passed through the filter 10, and supply the separation target liquid. It suffices that the opening 21 have a size and a shape sufficient to allow the first container 20 to receive at least the filter 10 provided to the second container 30. In the example illustrated in FIGS. 2A and 2B, the opening 21 has a circular shape.

The first container 20 has an inner wall surface 22. As illustrated in FIGS. 2A and 2B, the inner wall surface 22 may have a tapered side surface, and a bottom surface that faces the filter 10 when the second container 30 is placed in the first container 20. The inner wall surface 22 may have a columnar side surface (not illustrated in the drawings). The inner wall surface 22 may have a continuously curved shape.

Note that at least part of the inner wall surface 22 may be covered with a coating film similar to the coating film 18 that covers the filter 10. Specifically, at least part of the inner wall surface 22 may be hydrophilized. This makes it possible to suppress adhesion of cells having phagocytic activity (e.g., monocytes) to the inner wall surface of the first container 20, so that the separation efficiency of the separator can be improved.

The second container 30 has the first opening 31. The first opening 31 functions as an outlet for a filtrate that has passed through the filter 10. The first opening 31 also functions as an inlet for the separation target liquid. It suffices that the first opening 31 have a size and a shape sufficient to remove a filtrate that has passed through the filter 10, and supply the separation target liquid. In the example illustrated in FIGS. 2A and 2B, the first opening 31 has a circular shape.

The second container 30 has the second opening 32. It suffices that the second opening 32 have a size and a shape sufficient to provide the filter 10. In the example illustrated in FIGS. 2A and 2B, the second opening 32 has a circular shape.

The second container 30 has (is provided with) the filter 10. The filter 10 is provided to close the second opening 32. In the example illustrated in FIGS. 2A and 2B, since the second opening 32 has a circular shape, the filter 10 also has a circular planar shape. Although the filter 10 has a flat surface in the example illustrated in FIGS. 2A and 2B, the filter 10 may have a curved surface.

The second container 30 has a tubular body 34. The body 34 and the filter 10 may be formed integrally, or may be formed independently. The body 34 has an inner wall surface 35.

Note that at least part of the inner wall surface 35 may be covered with a coating film similar to the coating film 18 that covers the filter 10. Specifically, at least part of the inner wall surface 35 may be hydrophilized. The outer wall surface of the body 34 may similarly be hydrophilized. This makes it possible to suppress adhesion of cells having phagocytic activity (e.g., monocytes) to the inner wall surface and the outer wall surface of the second container 30, so that the separation efficiency of the separator can be improved.

1-3. Configuration of Separator 2

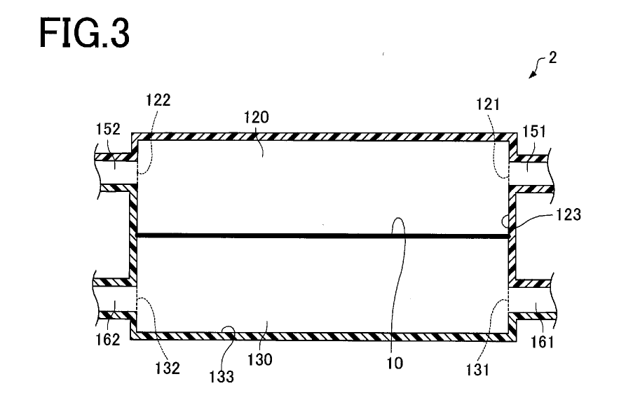

FIG. 3 is a cross-sectional view illustrating the separator 2 according to one embodiment of the invention.

The separator 2 according to one embodiment of the invention includes a first container 120 that has a first inlet 121 and a first outlet 122, and a second container 130 that has a second inlet 131 and a second outlet 132, and is continuous with the first container 120 through the filter 10.

The first container 120 has the first inlet 121 and the first outlet 122. The first inlet 121 functions as an inlet for the separation target liquid. The first inlet 121 is connected to a separation target liquid feed path 151. The first outlet 122 functions as an outlet for the separation target liquid that includes a filtration residual component and a washing agent. The first outlet 122 is connected to a separation target liquid discharge path (collection path) 152.

The first container 120 has an inner wall surface 123. As illustrated in FIG. 3, the inner wall surface 123 is formed by the filter 10 on the side of the second container 130. The entirety of the inner wall surface 123 on the side of the second container 130 may be formed by the filter 10 (see FIG. 3), or only part of the inner wall surface 123 on the side of the second container 130 may be formed by the filter 10.

Note that at least part of the inner wall surface 123 may be covered with a coating film similar to the coating film 18 that covers the filter 10. Specifically, at least part of the inner wall surface 123 may be hydrophilized. The inner wall surface of the feed path 151 and the discharge path 152 may also be hydrophilized. This makes it possible to suppress adhesion of cells having phagocytic activity (e.g., monocytes) to the inner wall surface of the first container 120, so that the separation efficiency of the separator can be improved.

The second container 130 has the second inlet 131 and the second outlet 132. The second inlet 131 functions as an inlet for the washing agent. The second inlet 131 is connected to a washing agent feed path 161. The second outlet 132 functions as an outlet for a filtrate and a washing agent. The second outlet 132 is connected to a filtrate discharge path 162.

The second container 130 has an inner wall surface 133. As illustrated in FIG. 3, the inner wall surface 133 is formed by the filter 10 on the side of the first container 120. The entirety of the inner wall surface 133 on the side of the first container 120 may be formed by the filter 10 (see FIG. 3), or only part of the inner wall surface 133 on the side of the first container 120 may be formed by the filter 10.

Note that at least part of the inner wall surface 133 may be covered with a coating film similar to the coating film 18 that covers the filter 10. Specifically, at least part of the inner wall surface 133 may be hydrophilized. The inner wall surface of the feed path 161 and the discharge path 162 may also be hydrophilized. Cells such as monocytes may change in size due to physical damage. The size of cells such as monocytes may differ depending on individual cells, and a small amount of cells may pass through the through-hole 15 of the filter 10. Therefore, the above configuration makes it possible to suppress adhesion of cells having phagocytic activity (e.g., monocytes) to the second container 130 and the discharge path 162 (i.e., clogging of the path due to adhesion of cells can be prevented), so that the separation efficiency of the separator can be improved.

### 2. SEPARATION METHOD

A cell separation method that utilizes the separator according to one embodiment of the invention is described below with reference to the drawings.

2-1. Separator 1

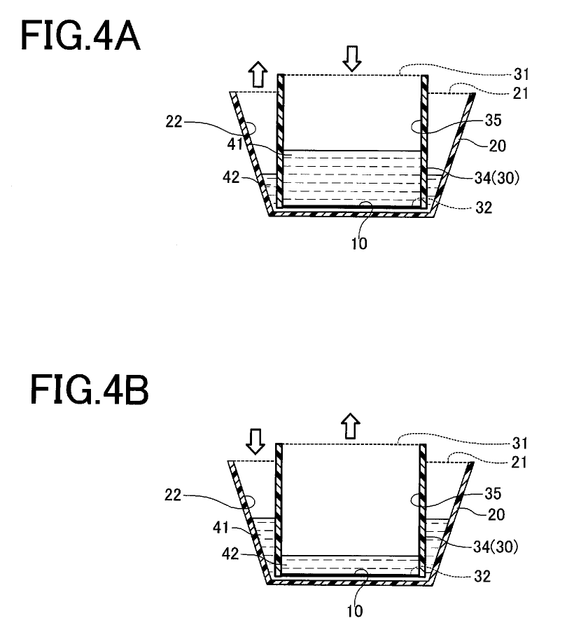

FIGS. 4A and 4B are cross-sectional views illustrating a separation method that utilizes the separator 1 according to one embodiment of the invention. Note that each arrow in FIGS. 4A and 4B indicates the liquid flow direction. The same elements as those illustrated in FIGS. 2A and 2B are indicated by identical reference signs, and detailed description thereof is omitted.

According to the separation method illustrated in FIG. 4A, a separation target liquid 41 is injected into the second container 30 through the first opening 31 of the second container 30, and a filtrate 42 that has passed through the filter 10 is collected through the opening 21 of the first container 20.

According to the separation method illustrated in FIG. 4B, the separation target liquid 41 is injected into the first container 20 through the opening 21 of the first container 20, and the filtrate 42 that has passed through the filter 10 is collected through the first opening 31 of the second container 30.

2-2. Separator 2

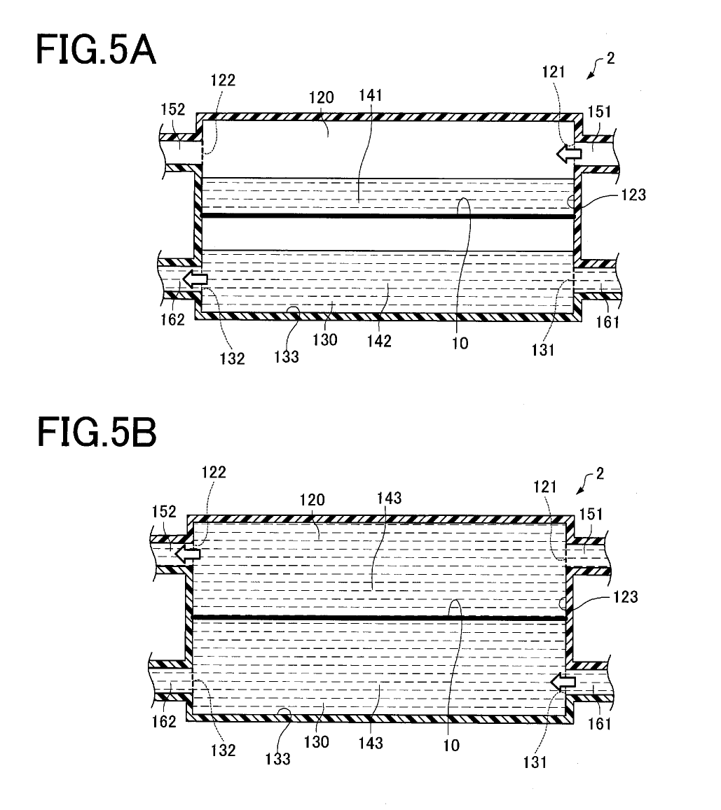

FIGS. 5A and 5B are cross-sectional views illustrating a separation method that utilizes the separator 2 according to one embodiment of the invention. Note that each arrow in FIGS. 5A and 5B indicates the liquid flow direction. The same elements as those illustrated in FIG. 3 are indicated by identical reference signs, and detailed description thereof is omitted.

As illustrated in FIG. 5A, the discharge path 152 and the feed path 161 are closed during filtration using a valve or the like (not illustrated in the drawings) since only the feed path 151 and the discharge path 162 are used.

In the filtration step, a separation target liquid 141 is injected into the first container 120 through the opening 121 of the first container 120, and a filtrate 142 that has passed through the filter 10 is collected through the outlet 132 of the second container 130.

In the residual component (i.e., particles that had not passed through the filter 10) collection (washing) step (see FIG. 5B), the feed path 151 and the discharge path 162 are closed using a valve or the like (not illustrated in the drawings) since only the feed path 161 and the discharge path 152 are used.

In the collection (washing) step, a washing agent 143 is injected into the second container 120 through the second inlet 131 of the second container 130, and a washing agent 143 containing residual components that has passed through the filter 10 is collected through the outlet 122 of the first container 120.

Note that the collection (washing) step may be performed in a state in which the discharge path 162 is open. This makes it possible to discharge the filtrate 142 that remains in the second container 130 through the discharge path 162 using the washing agent 143.

### 3. EXAMPLES

The invention is further described below by way of examples and comparative examples. The following examples will demonstrate the clogging suppression effect achieved by the filter 10 and the like.

### Example 1

Au was deposited on the surface of an Si substrate to form an Au film (thickness: 300 nm). A self-assembled monolayer (SAM) was formed on the Au film (SAM treatment). More specifically, the surface of the substrate was UV-cleaned (nm, W×5 min), and the substrate was immersed for 4 hours in a solution prepared by dissolving (diluting) an alkanethiol compound having a polyethylene glycol chain (PEG thiol) in (with) ethanol (0.1%). The substrate was washed with ethanol, and then washed with purified water. The PEG chain length of the PEG thiol compound was 3 (SAM treatment condition 1). The surface of the substrate obtained by the PEG thiol treatment had a contact angle with water of about 39° (i.e., hydrophilic). Note that the contact angle with water was determined by measuring the contact angle of the substrate with purified water using a contact angle meter (“CA-W” manufactured by Kyowa Interface Science Co., Ltd.).

10 ml of peripheral blood was 2-fold diluted with a phosphate buffer (PBS), and subjected to density-gradient centrifugation (400×g, 30 min) using a reagent “Ficoll-paque” (manufactured by GE healthcare) to collect a buffy coat. The buffy coat was resuspended in PBS, and reprecipitated by centrifugation, and the supernatant liquid was removed. This operation was repeated two or three times to obtain mononuclear cells. Since the mononuclear cells (lymphocytes and monocytes) are separated in the buffy coat, and the monocytes exhibit strong adhesion to the substrate, the number of cells adhering to the substrate was counted as the number of monocytes. The mononuclear cells were suspended in PBS at a concentration of 1×10⁶ cells/ml. 50 microliters of the cell suspension was dripped onto the surface of an Au-deposited substrate in which an opening having a diameter of 5 mm was formed, and allowed to stand for 30 minutes. After washing the surface of the substrate with PBS, the number of monocytes adhering to the surface of the substrate was measured using a microscope (measurement range: 0.4×0.6 mm).

Immature dendritic cells obtained by differentiation from peripheral monocytes were suspended in a medium at a concentration of 2×10⁶ cells/ml. 50 microliters of the cell suspension was dripped onto the surface of an Au-deposited substrate in which an opening having a diameter of 5 mm was formed, and allowed to stand for 30 minutes. After washing the surface of the substrate with PBS, the number of dendritic cells adhering to the surface of the substrate was measured using a microscope (measurement range: 0.4×0.6 mm).

The number of dendritic cells was 249, and the number of monocytes was 700. The adhesion rate was calculated based on the number of dendritic cells or the number of monocytes. The number of dendritic cells was measured at 4° C., room temperature, and 37° C.

### Example 2

In Example 2, the PEG chain length of the PEG thiol compound was changed to 5 (SAM treatment condition 2). The surface of the substrate obtained by the PEG thiol treatment had a contact angle with water of about 37° (i.e., hydrophilic). The substrate was prepared in the same manner as in Example 1, except that the PEG chain length and the contact angle of the surface were changed as described above.

### Example 3

In Example 3, the PEG chain length of the PEG thiol compound was changed to 6 (SAM treatment condition 3). The surface of the substrate obtained by the PEG thiol treatment had a contact angle with water of about 36° (i.e., hydrophilic). The substrate was prepared in the same manner as in Example 1, except that the PEG chain length and the contact angle of the surface were changed as described above.

### Example 4

In Example 4, a filter in which a plurality of through-holes were formed in an Ni substrate was used instead of the Si substrate. A self-assembled monolayer (SAM) was formed on a gold thin film in the same manner as in Example 1 (SAM treatment condition 1), except that the Ni substrate was used. Note that only the number of dendritic cells adhering to the surface of the substrate was measured.

### Example 5

In Example 5, a filter in which a plurality of through-holes were formed in an Ni substrate was used instead of the Si substrate. A self-assembled monolayer (SAM) was formed on a gold thin film in the same manner as in Example 2 (SAM treatment condition 2), except that the Ni substrate was used. Note that only the number of dendritic cells adhering to the surface of the substrate was measured.

### Example 6

In Example 6, a filter in which a plurality of through-holes were formed in an Ni substrate was used instead of the Si substrate. A self-assembled monolayer (SAM) was formed on a gold thin film in the same manner as in Example 3 (SAM treatment condition 3), except that the Ni substrate was used. Note that only the number of dendritic cells adhering to the surface of the substrate was measured.

### Example 7

A filtration system including a filter material (polycarbonate), a filter housing member (polystyrene), and a filtrate/residue collection container (e.g., polypropylene, polyvinyl chloride, acrylic resin, nylon resin, polyurethane resin, polyurea resin, or glass) was immersed in a hydrophilizing agent (MPC polymer manufactured by NOF Corporation, 0.5% ethanol solution) to hydrophilize the surface of the member (MPC treatment). Peripheral blood was 4-fold diluted with PBS, and filtered using the filtration system subjected to the hydrophilization treatment.

The number of blood cells in the filtrate and the residue was measured using a hematology analyzer (“XE-2100” manufactured by Sysmex Corporation), and the number of the respective blood cells was compared with the number of the respective blood cells before filtration to calculate the collection rate of the respective blood cells using the filtration system.

### Comparative Example 1

In Comparative Example 1, a substrate on which a self-assembled monolayer (SAM) was not formed was used. The number of cells adhering to the surface of the substrate was measured in the same manner as in Example 1, except that the substrate was changed.

### Comparative Example 2

In Comparative Example 2, a filter in which a plurality of through-holes were formed in an Ni substrate, and a gold thin film and a self-assembled monolayer (SAM) were not formed on the Ni substrate, was used instead of the Si substrate. The number of cells adhering to the surface of the substrate was measured in the same manner as in Example 1, except that the substrate was changed.

### Comparative Example 3

In Comparative Example 3, the same filter as that used in Comparative Example 2 that was subjected to only UV-cleaning in the same manner as in Example 1, was used. The number of cells adhering to the surface of the substrate was measured in the same manner as in Example 1, except that the substrate was changed.

### Comparative Example 4

In Comparative Example 4, a filter in which a plurality of through-holes were formed in an Ni substrate, and only a gold thin film was formed on the Ni substrate, was used instead of the Si substrate. The number of cells adhering to the surface of the substrate was measured in the same manner as in Example 1, except that the substrate was changed.

### Comparative Example 5

In Comparative Example 5, a plastic culture dish on which a gold thin film and a self-assembled monolayer (SAM) were not formed was used instead of the Si substrate. The number of cells adhering to the surface of the substrate was measured in the same manner as in Example 1, except that the substrate was changed.

### Comparative Example 6

In Comparative Example 6, a plastic member (“Chemotaxicell” manufactured by Kurabo Industries, Ltd., material: polystyrene) which is used as a housing of a filtration system, and on which a gold thin film and a self-assembled monolayer (SAM) were not formed, was used instead of the Si substrate. The number of cells adhering to the surface of the substrate was measured in the same manner as in Example 1, except that the substrate was changed. Note that only the number of monocytes adhering to the surface of the substrate was measured.

### Comparative Example 7

In Comparative Example 7, a plastic member (“Chemotaxicell” manufactured by Kurabo Industries, Ltd., material: polystyrene) which is used as a case of a filtration system, and on which a gold thin film and a self-assembled monolayer (SAM) were not formed, was used instead of the Si substrate. The number of cells adhering to the surface of the substrate was measured in the same manner as in Example 1, except that the substrate was changed.

### Comparative Example 8

In Comparative Example 8, the same filtration system as that used in Example 7 that was not subjected to the MPC treatment was used. The collection rate of the respective blood cells was calculated in the same manner as in Example 7, except that the filtration system was not subjected to the MPC treatment.

Tables 1 and 2 show the measurement results obtained in Examples 1 to 7 and Comparative Examples 1 to 8. Note that Table 1 shows the measurement results obtained in Examples 1 to 6 and Comparative Examples 1 to 7, and Table 2 shows the measurement results obtained in Example 7 and Comparative Example 8.

TABLE 1

| | | | | Number of |
|---|---|---|---|---|
| | | | | adhering |
| | | | | monocytes |
| | Number of adhering dendritic | | | (adhesion |
| | cells (adhesion rate (%)) | | | rate (%)) |
| | | Room | | Room |
| | 4° C. | temperature | 37° C. | temperature |
| Example 1 | 0 | 1 | 0 | 0 |
| Example 2 | 0 | 0 | 0 | 0 |
| Example 3 | 0 | 0 | 0 | 0 |
| Example 4 | 0 | 3 | 0 | — |
| Example 5 | 0 | 2 | 0 | — |
| Example 6 | 0 | 0 | 0 | — |
| Comparative | 61 (24.4%) | 179 (71.9%) | 227 (91.2%) | 573 (81.9%) |
| Example 1 | | | | |
| Comparative | 21 (8.4%) | 125 (50.2%) | 236 (94.8%) | — |
| Example 2 | | | | |
| Comparative | 62 (33.3%) | 68 (27.3%) | 184 (73.9%) | — |
| Example 3 | | | | |
| Comparative | 9 (3.6%) | 44 (17.7%) | 137 (55.0%) | — |
| Example 4 | | | | |
| Comparative | 5 (2.0%) | 107 (43.0%) | 223 (89.6%) | 433 (61.9%) |
| Example 5 | | | | |
| Comparative | — | — | — | 423 (60.4%) |
| Example 6 | | | | |
| Comparative | — | — | — | 660 (94.3%) |
| Example 7 | | | | |

| | | |
|---|---|---|
| Reference | 249 (100%) | 700 (100%) |

TABLE 2

| | Collection | Collection | Collection | Collection | Collection | Collection | Collection |
|---|---|---|---|---|---|---|---|
| | rate (%) | rate (%) | rate (%) | rate (%) | rate (%) | rate (%) | rate (%) |
| | Erythrocytes | Platelets | Neutrophils | Lymphocytes | Monocytes | Acidophils | Basophils |
| Example 7 | 85.9 | 68.0 | 81.6 | 78.4 | 88.9 | 50.0 | 0.0 |
| Comparative | 81.9 | 64.0 | 71.1 | 80.4 | 55.6 | 50.0 | 0.0 |
| Example 8 | | | | | | | |

3-1. Evaluation of Adhesion Rate Reduction Effect

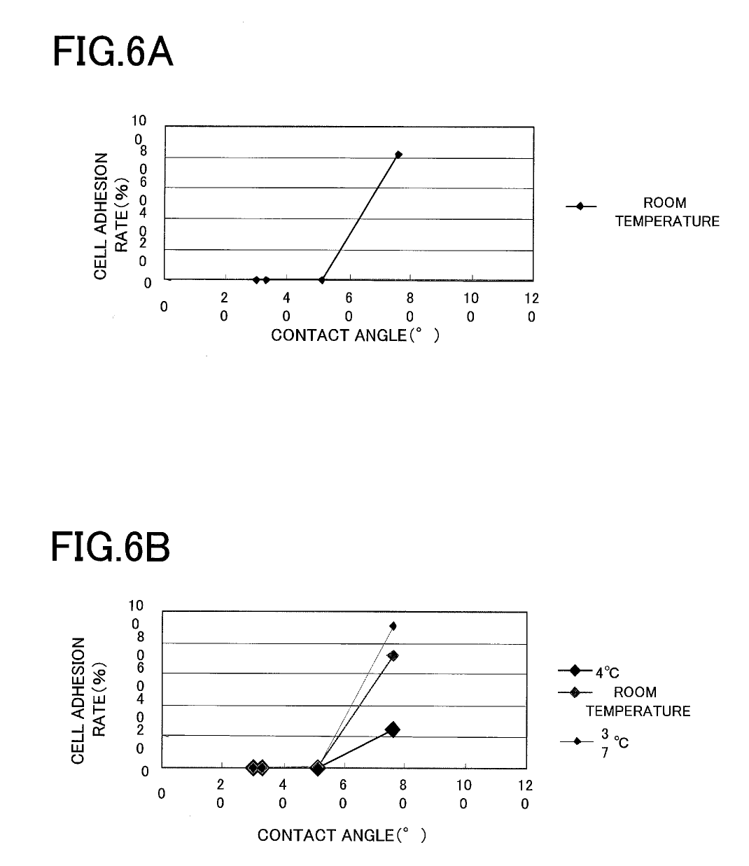

FIG. 6A is a graph illustrating the relationship between the monocyte measurement results and the contact angle of the surface of the substrate (Examples 1 to 3 and Comparative Example 1). As illustrated in FIG. 6A, while adhesion of monocytes was not observed in Examples 1 to 3, the monocyte adhesion rate was 81.9% in Comparative Example 1 in which the SAM treatment was not performed. Adhesion of monocytes was not observed when the contact angle with water was 70° or less (30 to 50°).

It was thus confirmed that adhesion of monocytes could be significantly suppressed by hydrophilizing the surface of the filter.

FIG. 6B is a graph illustrating the relationship between the dendritic cell measurement results, the contact angle of the surface of the substrate, and the temperature (Examples 1 to 3 and Comparative Example 1). As illustrated in FIG. 6B, while adhesion of dendritic cells was not observed in Examples 1 to 3, the dendritic cell adhesion rate (room temperature) was 71.9% in Comparative Example 1 in which the SAM treatment was not performed. Adhesion of dendritic cells was not observed when the contact angle with water was 70° or less (30 to 50°). When the temperature was increased from room temperature to 37° C., the dendritic cell adhesion rate increased to 91.2% in Comparative Example 1, while an increase in adhesion rate was not observed in Examples 1 to 3.

It was thus confirmed that adhesion of dendritic cells could be significantly suppressed by hydrophilizing the surface of the filter. It was also confirmed that adhesion of dendritic cells could be suppressed even at a temperature (37° C.) equal to or higher than room temperature.

3-2. Evaluation of Collection Rate of Separator

As shown in Table 2, a significant difference in collection rate was observed for only monocytes having phagocytic activity. An adhesion suppression effect was not observed for the blood components (erythrocytes, platelets, and lymphocytes) other than monocytes. A slight reduction in collection loss was observed for neutrophils. Therefore, it is considered that the hydrophilization treatment on each filter member suppresses an adhesion mechanism of phagocytes such as monocytes (neutrophils) instead of merely suppressing physical adsorption.

It was thus confirmed that cells having phagocytic activity can be more efficiently separated by hydrophilizing the members of the separator including the filter.

3-3. Evaluation of Substrate Material

In Examples 4 to 6 in which the Ni filter was used, adhesion of cells could be suppressed by hydrophilizing the surface of the filter. It was confirmed from the results obtained in Comparative Examples 2 to 4 that adhesion of cells significantly occurs when using a metal member (e.g., Au or Ni). It was confirmed from the results obtained in Comparative Examples 5 to 7 that adhesion of cells significantly occurs when using a plastic member.

It was thus confirmed that adhesion of cells to the surface of a filter and a peripheral member (e.g., housing and path) occurs when using a separator (e.g., filtration system) that utilizes a filter.

Note that the above embodiments and the modifications thereof are merely examples, and the invention is not limited to the above embodiments and the modifications thereof. For example, a plurality of embodiments and/or a plurality of modifications may be appropriately combined.

The invention is not limited to the above embodiments and the examples. Various modifications and variations may be made of the above embodiments and the examples without departing from the scope of the invention. The invention includes various other configurations that are substantially the same as the configurations described in connection with the above embodiments (e.g., a configuration having the same function, method, and results, or a configuration having the same objective and results). The invention also includes a configuration in which an unsubstantial section (element) described in connection with the above embodiments is replaced with another section (element). The invention also includes a configuration having the same effects as those of the configurations described in connection with the above embodiments, or a configuration capable of achieving the same objective as that of the configurations described in connection with the above embodiments. The invention further includes a configuration in which a known technique is added to the configurations described in connection with the above embodiments.

Although only some embodiments of the invention have been described in detail above, those skilled in the art would readily appreciate that many modifications are possible in the embodiments without materially departing from the novel teachings and advantages of the invention. Accordingly, all such modifications are intended to be included within the scope of the invention.

What is claimed is:

1. A separator that fractionates a dispersion of cells including cells having phagocytic activity corresponding to a size of the cells to obtain a dispersion in which a content of the cells having phagocytic activity is higher than that of the dispersion, the separator comprising:
a filter,
at least part of the filter having a hydrophilic surface as a result of being covered with at least one of a self-assembled monolayer that includes an alkanethiol having a nonionic hydrophilic group that is formed on a gold thin film via a sulfur-gold bond, and a homopolymer or a copolymer of an ester of (meth)acrylic acid and at least some of hydrophilic groups of phospholipids that form a biomembrane.

2. The separator as defined in claim 1,
the nonionic hydrophilic group being a polyethylene glycol group.

3. The separator as defined in claim 1,
the phospholipids that form the biomembrane being glycerophospholipids.

4. The separator as defined in claim 3, the ester of (meth)acrylic acid and at least some of the hydrophilic groups of the phospholipids that form the biomembrane being 2-(meth)acryloyloxyethylphosphorylcholine.

5. The separator as defined in claim 1,
the cells having phagocytic activity having a scavenger receptor on a surface thereof.

6. The separator as defined in claim 1,
the cells having phagocytic activity being at least one type of cells among monocytes, dendritic cells, and macrophages.

7. The separator as defined in claim 1,
the hydrophilic surface of the filter having a contact angle with water of 70° or less.

8. The separator as defined in claim 1,
the hydrophilic surface being formed in at least an area with which the cells having phagocytic activity come in contact.

9. The separator as defined in claim 1, further comprising:
a first container that has an opening; and
a tubular second container that has a first opening, a second opening that is opposite to the first opening, and the filter that closes the second opening,
the filter of the second container being placed in the first container, and
at least part of an inner wall surface of the first container and the second container having the hydrophilic surface.

10. The separator as defined in claim 1, further comprising:
a first container that has a first inlet and a first outlet; and
a second container that has a second inlet and a second outlet, and is continuous with the first container through the filter,
at least part of an inner wall surface of the first container having the hydrophilic surface.

11. The separator as defined in claim 2,
the phospholipids that form the biomembrane being glycerophospholipids.

12. The separator as defined in claim 11,
the ester of (meth)acrylic acid and at least some of the hydrophilic groups of the phospholipids that form the biomembrane being 2-(meth)acryloyloxyethylphosphorylcholine.

13. The separator as defined in claim 2,
the cells having phagocytic activity having a scavenger receptor on a surface thereof.

14. The separator as defined in claim 3,
the cells having phagocytic activity having a scavenger receptor on a surface thereof.

15. The separator as defined in claim 4,
the cells having phagocytic activity having a scavenger receptor on a surface thereof.

16. The separator as defined in claim 11,
the cells having phagocytic activity having a scavenger receptor on a surface thereof.

17. The separator as defined in claim 2,
the cells having phagocytic activity being at least one type of cells among monocytes, dendritic cells, and macrophages.

18. The separator as defined in claim 3,
the cells having phagocytic activity being at least one type of cells among monocytes, dendritic cells, and macrophages.

19. The separator as defined in claim 4,
the cells having phagocytic activity being at least one type of cells among monocytes, dendritic cells, and macrophages.

20. The separator as defined in claim 5,
the cells having phagocytic activity being at least one type of cells among monocytes, dendritic cells, and macrophages.
